(19) United States
(12) Patent Application Publication
(10) Pub. No.: US 2002/0067907 A1
(43) Pub. Date: Jun. 6, 2002

(54) Universal video client/universal video server system

(76) Inventor: Eric Ameres, Cohoes, NY (US)

Correspondence Address: Peter L. Berger, Esq., LEVISOHN, LERNER, BERGER & LANGSAM, Suite 2400, 757 Third Avenue, New York, NY, 10017, US

(21) Appl. No.: 09/876,593

(22) Filed: Jun. 7, 2001

Related U.S. Application Data
(60) Provisional application No. 60/209,844, filed on Jun. 6, 2000.

(51) Int. Cl. H04N 5/76

(52) U.S. Cl. 386/46; 386/111

(57) ABSTRACT

The present invention is a system for serving and playing back a video stream spliced from a plurality of disparate video segments. The system has a video splicing server on the server side and a client application for playback on the client's side. The client application is a plug-in that enables the user's browser program, preferably Netscape and Internet Explorer, to play any known streaming media format. In order to view the streaming presentation, viewer will connect to a presentation server using the provided client software. The splicing server, which is used to create a seamless presentation, dynamically splices together disparate segments of the video presentation and feeds the client's side a sequence of pointers to these video segments, which are played by the provided client software in the order presented, resulting in a coherent show.

### FIELD OF THE INVENTION

The present invention relates to the field of delivering video presentations created in a variety of different formats to a viewer. More specifically, the present invention relates to the method and apparatus for creating a seamless video stream comprising video segments from disparate video sources and for allowing a viewer to view the video stream regardless of the format the video segments were created in.

### BACKGROUND OF THE INVENTION

Wold Wide Web servers are often described as “stateless” because a typical web server takes a request for information, processes it, provides information, completes the transaction, disconnects and moves on to a next request. On the client's side, a web browser takes the information it receives, assembles it on the screen, and then ignores the web server until a user clicks on a link. This stateless approach works well for media like graphics and text. But, transferring moving images and sounds is problematic. Unlike a graphic image, animation and sound have a time element attached to them. Under the stateless approach, a web user would need to download the entire video clip before it can be viewed. But with the large file size that comes even with a short video clip, the wait becomes unacceptably long.

A solution to the problem is streaming video. Streaming video is a sequence of “moving images” that are sent in compressed form over the Internet and displayed by the viewer as they arrive. Streaming media is streaming video with sound. With streaming video or streaming media, a web user does not have to wait to download a large file before seeing the video or hearing the sound. Instead, the media is sent in a continuous stream and is played as it arrives. The user needs a player, which is a special program that decompresses and sends video data to the display and audio data to speakers. A player can be either an integral part of a browser or downloaded from the software maker's Web site. Streaming video is usually sent from prerecorded video files, but can be distributed as part of a live broadcast “feed.” In a live broadcast, the video signal is converted into a compressed digital signal and transmitted from a special Web server that is able to do multicasting, sending the same file to multiple users at the same time.

Major streaming video and streaming media technologies include RealSystem G2 from RealNetwork, Microsoft Windows Media Technologies (including Advanced Streaming Format (ASF) and Apple's Quicktime. The other approaches use proprietary algorithms. Real Media technology from Real Networks offers a range of choices for a web producer. A Real Media player handles audio, video, animation, still images and text. However, no player application is currently available for Macintosh users. Windows Media Technologies and their Advanced Streaming Format (ASF), manufactured by Microsoft Corp., is another streaming media solution currently available to web producers and other users. Despite a variety of tools offered by ASF as a free download from the company's website, this technology, similarly to the Real Media technology, does not provide adequate support for Macintosh users. Quicktime is a multimedia development, storage, and playback technology from Apple. Quicktime files combine sound, text, animation, and video in a single file. Using a Quicktime player that either comes with a Web browser or can be downloaded from Apple's website or the browser company's website, a user can view and control brief multimedia sequences. One of the advantages of Quicktime is that its latest version can support a wide array of different formats. However, on the server side, Quicktime streaming media technology provides users with relatively limited choices, compared for example with Real Media technology.

Because streaming media may be produced in any of the above described formats, web viewers and producers are often frustrated that there is no one fixed streaming format allowing them to create and view a single media presentation without choosing between the different formats. This concern will become even greater in the future because today most people watch video or listen to audio but in the near future, streaming content will be integrated and interactive multimedia put together from a variety of resources into a single multimedia presentation. Thus, there is a substantial interest in the art for a solution which would allow a server to put together a seamless streaming presentation from several disparate video segments and would allow a viewer to view the created presentation regardless of the original format of its constituent video segments.

### SUMMARY OF THE INVENTION

It is an object of the present invention to provide a universal video server which will provide a seamless video presentation by dynamically splicing together disparate video segments created in different streaming and compression formats.

It is another object of the present invention to provide a client software allowing its user to view the seamless video presentation regardless of the streaming and/or compression formats used to create its segments.

Further objects of the invention will become apparent in conjunction with the disclosure herein.

In accordance with the preferred embodiment of the present invention a system for serving and playing back a video stream comprising a plurality of disparate video segments is provided. The system has a video splicing server on the server side and a client application for playback on the client's side. The client application is a plug-in that enables the user's browser program, preferably Netscape and Internet Explorer, to play any known streaming media format. In order to view the streaming presentation, viewer will connect to a presentation server using the provided client software. The splicing server, which is used to create a seamless presentation, dynamically splices together disparate segments of the video presentation and feeds the client's side a sequence of pointers to these video segments, which are played by the provided client software in the order presented, resulting in a coherent show.

### BRIEF DESCRIPTION OF THE DRAWINGS

A full understanding of the invention can be gained from the following description of the preferred embodiment when read in conjunction with the accompanying drawings in which:

FIG. 1 is a schematic diagram of a single video stream spliced from a plurality of disparate video segments; and

FIG. 2 is a schematic diagram of the video splicing server streaming a spliced video stream to the client's side, where the stream is played back using the client application provided by the present invention.

### DETAILED DESCRIPTION OF THE PREFERRED EMBODIMENT

The following detailed description describes the invention in connection with the client application already partially implemented as the Universal Streaming Media Client (USMC) which is currently available from on2.com, the website created by the inventors herein and containing entertainment and news video materials and information. It is to be understood, however, that the present invention can be implemented with any Internet database regardless of its specific content. Any commercially available video compression algorithm may be used to deliver video in connection with the present invention.

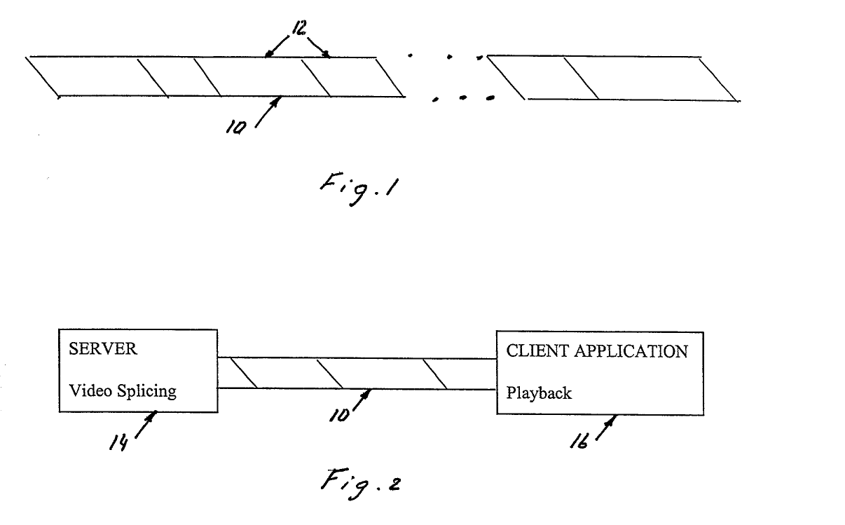

In accordance with the present invention a system for serving and playing back a spliced video stream is provided. As shown in FIG. 1, in the preferred embodiment the video stream 10 is spliced by combining together, in a single stream, a plurality of disparate video segments 12. Each of the segments 12 may have been created using any of the currently known streaming and compression formats, and is inserted into the video stream 10 in this original format, i.e., without converting it into any common format. A video splicing server 14, see FIG. 2, is responsible for splicing together the video stream 10 in the described above manner. The video stream is then transmitted to a client's system where it may be played back by a viewer, using a provided client application 16 capable of playing back a video stream spliced from disparate video segments created in different formats.

In accordance with the preferred embodiment of the present invention a client application is provided which is a plug-in that enables the user's browser program, preferably Netscape and Internet Explorer, to play any known streaming media format. Plug-in applications are programs that can be installed and used as part of the web browser. A plug-in application is recognized automatically by the browser and its function is integrated into the main HTML file that is being presented. The USMC is a client plug-in application that allows viewers to play back audio/video in a variety of streaming and compression formats. For the most part, support of these formats is effected via standard developer libraries provided by the format vendors and intended for incorporation into third party applications. Other enabling fact is that, at least in the broadband environment, client download is relatively painless and does not meet user resistance.

In the preferred embodiment of the present invention, the client software will support streaming formats of True Cast, currently available from On2.com, Microsoft Windows Media, currently available from Microsoft Corp., Quicktime, currently available from Apple Corp., and Real Networks streaming technology. Of course any other streaming format may also be supported if it gains momentum.

Regarding compression formats, all currently standard playback codecs will preferably be supported, often via automatic download. The preferred embodiment of the present invention includes Microsoft's MPEG-4 video, Microsoft's audio codec, Apple's Soreson Video, and Apple's standard audio (Qdesign Music Codec). Real Networks codecs and other popular codecs may also be provided.

The client software will preferably support On2.com proprietary codecs. One of the main commercial advantages gained by this support is that codecs need not to be published as such, in other words, they can be included in the client software and only be accessible via the client software. This affords greater flexibility in usage of the proprietary compression formats and control over the business model, reducing the risk of marginalization associated with positioning the company as a “codec company”.

In order to view the streaming presentation, viewer will connect to a presentation server using the provided client software. The presentation server dynamically splices together disparate segments of the video presentation and feeds the client's side a sequence of pointers to these video segments, which are played by the provided client software in the order presented, resulting in a coherent show. The video segments will preferably be spliced together by the server into a single seamless video presentation in their original formats. For example, segments created in Quicktime format may follow segments created in Windows Media format or Real Networks format, without converting any of the segments into a common streaming and/or compression format. The segments can originate from different video sources and be served from disparate hosts on the internet, using an arbitrary mix of supported streaming and compression formats; segment generation can be dynamic.

One of the advantages of this type of service is that a server can serve dynamically targeted advertisements using any preferred streaming and compression format between segments of more or less arbitrary third party video content. In the preferred embodiment, when targeted advertisements are served from one of the On2.com servers, the advertising segments are preferably created and sent in the proprietary TrueCast/VP3 format. In an alternative embodiment, an advertiser could make their existing advertisements available to the video streaming website without re-hosting or re-compressing the advertising segments.

The present invention will allow the host of the splicing server to incrementally sell its services to content providers. Additionally, the system is more convenient for the customers who need not adopt a particular streaming or compression technology completely, immediately or irrevocably. Furthermore, client support of other compression formats facilitates comparison, allowing a user to choose the best available format for permanent use. In short, the server's host will be able to sell its proprietary streaming and compression services on their merits without requiring the customers to assume unacceptable risks.

In the preferred embodiment of the present invention, the client application only functions on a live internet connection, preferably only on a live broadband connection, which allows the server to control its functionality and to change the functionality in accordance with the host's business objectives. For example, the client application may only function when the user is connected to the host's presentation server. Alternatively, the client application may always allow Microsoft, Quicktime or Real Networks playback, but only makes proprietary playback technology available when the client application is attached to the server. In the On2.com case, the VP3 streaming technology will preferably be available only when the client application is attached to its TrueCast server or to an On2.com presentation server. In another alternative embodiment of the present invention, the client application will allow its user to play back all kinds of video presentations using all available technologies and then will report users' behavior to an On2.com demographic database. In a further alternative embodiment, the client application will be provided free of charge but it will feature a permanent link to the host's server. For example, most users will begin by using such freebie client software on non-On2.com sites but the software will have a prominent link to On2.Com and/or interesting partner sites which will eventually bring the users to these sites.

Having described this invention with regard to specific embodiments, it is to be understood that the description is not meant as a limitation since further variations or modifications may be apparent or may suggest themselves to those skilled in the art. It is intended that the present application cover such variations and modifications as fall within the scope of the appended claims.

I claim as follows:

1. A system for serving and playing back a spliced video stream comprised of disparate video segments, comprising:
a server system further comprising
1. means for combining a plurality of video segments into said spliced video stream;
2. means for streaming said spliced video stream to a client's system; and
the client's system further comprising
3. software means for playing back said spliced video stream regardless of the format each of said plurality of video segments was created in, said software means further comprising a plurality of playback formats, each of said playback formats being configured to enable said client's system to playback at least one of said plurality of video segments.

2. A system according to claim 1 wherein said video segments have different formats.

3. A system according to claim 1 further comprising means for compressing said video stream.

4. A system according to claim 1 wherein said playback format is Microsoft Windows Media format.

5. A system according to claim 1 wherein said playback format is Quicktime format.

6. A system according to claim 1 wherein said playback format is Real Networks format.

7. A method for serving and playing back a spliced video stream comprised of disparate video segments, comprising the steps of:
under control of a server system
1. combining a plurality of video segments into said spliced video stream;
2. streaming said spliced video stream to a client's system; and
under control of the client's system
3. playing back said spliced video stream regardless of the format each of said plurality of video segments was created in, said playing back step further comprising using a plurality of playback formats, each of said playback formats enabling said client's system to playback at least one of said plurality of video segments.

8. A method according to claim 7 wherein said video segments have different formats.

9. A method according to claim 7 further comprising the step of compressing said video stream.
